(19) United States
(12) Patent Application Publication
(10) Pub. No.: US 2018/0104811 A1
(43) Pub. Date: Apr. 19, 2018

(54) HAND-HELD POWER TOOL

(71) Applicant: Hilti Aktiengesellschaft, Schaan (LI)

(72) Inventors: Ralf Meixner, Germaringen (DE); Markus Hunger, Augsburg (DE); Manfred Jakob, Kaufering (DE)

(21) Appl. No.: 15/568,164

(22) PCT Filed: Apr. 22, 2016
(86) PCT No.: PCT/EP2016/059017

§ 371 Date: Oct. 20, 2017

(30) Foreign Application Priority Data
Apr. 24, 2015 (EP) 15165009.0

(51) Int. Cl. B25F 5/00; B25D 17/20; B23Q 11/12; H02K 7/14

(52) U.S. Cl. CPC B25F 5/008; B25D 17/20; B25D 2250/095; H02K 7/145; B25D 2217/0061; B23Q 11/127

(57) ABSTRACT

A hand-held power tool, in particular a hammer drill or combi-hammer, including a tool housing having an accommodating region designed for accommodating a rechargeable tool battery, wherein, in the accommodating region, a contact region for electrically contacting the rechargeable tool battery as well as a connection region that is electrically connected to the contact region is provided, wherein the connection region is designed to convey a supply current provided by the rechargeable tool battery to an electric drive motor of the hand-held power tool, wherein the hand-held power tool has a cooling fan arranged in the tool housing and operated by the electric drive motor, by which cooling air for cooling the accommodating region can be sucked through the accommodating region, wherein at least one partitioning element is provided in the accommodating region in such a way that the contact region remains substantially free from cooling air sucked through the accommodating region.

The present invention relates to a hand-held power tool, in particular a hammer drill or a combi-hammer, including a tool housing which has an accommodating area designed for accommodating a rechargeable tool battery. A contact area for electrically contacting the rechargeable tool battery as well as a connection area which is electrically connected to the contact area are provided in the accommodating area. The connection area is configured for conducting a supply current provided by the rechargeable tool battery to an electric drive motor of the hand-held power tool. The hand-held power tool further includes a cooling fan situated in the tool housing and operated by the electric drive motor, with the aid of which cooling air may be drawn in through the accommodating area for the purpose of cooling the accommodating area.

### BACKGROUND

In particular, the contact area for electrically contacting the rechargeable tool battery may heat up considerably, as is known, due to the current flowing through the contact area during the operation of the hand-held power tool, and must therefore be cooled.

### SUMMARY OF THE INVENTION

It is an object of the present invention to provide a hand-held power tool which is particularly low-wear. The object is achieved in the case of a hand-held power tool of the type mentioned at the outset in that at least one partitioning element is provided in the accommodating area in such a way that the contact area remains essentially free from cooling air drawn in through the accommodating area.

The present invention incorporates the finding that cooling air is typically drawn in from the immediate surroundings of a hand-held power tool and this cooling air is frequently contaminated by small dust and dirt particles of the type typically occurring at construction sites. As a result of drawing in cooling air containing dust or particulates through the accommodating area for the purpose of cooling the accommodating area, cooling air disadvantageously also passes by the contact area to the rechargeable tool battery, the contact area wearing more quickly.

Due to the partitioning element according to the present invention, the contact area now remains essentially free from drawn-in cooling air, so that contaminants or, for example, moisture contained in the cooling air may not cause wear—up to the point of failure—of the contact area. According to the present invention, air-cooling of the accommodating area therefore takes place with the exception of at least the contact area.

In one preferred embodiment, the partitioning element is designed as a partition wall, as a flexible seal, or as a chamber. The partitioning element may also be implemented in the form of an applied quantity of grease as the sealing element. Particularly preferably, the partitioning element is provided between the contact area and the connection area. An effective heat dissipation may then take place via the connection area.

It has been proven advantageous when the contact area and the connection area are thermally conductively connected to each other, so that a heat quantity introduced into the contact area may be dissipated via the connection area. Since, according to the present invention, no cooling air flows around the contact area, effective heat dissipation may take place nevertheless.

A heat-conducting element, which is thermally conductively connected to the connection area, is preferably connected downstream from the connection area in the direction of the machine electronics system, so that a heat quantity introduced into the connection area may be dissipated via the heat-conducting element. In order to further improve heat dissipation via the heat-conducting element, the heat-conducting element preferably includes a heat sink which is designed for the incident flow of the cooling air for the purpose of cooling and is therefore situated in the accommodating area.

The heat-conducting element is preferably designed as a current-carrying litz wire or includes such a current-carrying litz wire. The current-carrying litz wire may be surrounded by an insulation, at least in sections. In one alternative preferred embodiment, the contact area, the connection area, and the heat-conducting element, together, are designed as a one-piece component. The one-piece component is preferably a contact rail. The contact rail may, for example, be made of copper or include copper.

Preferably, the connection area includes a crimped joint or a welded joint for electrically and thermally conductively connecting the heat-conducting element to the contact element. The connection area itself may be formed by a crimped joint or a welded joint.

It has proven particularly advantageous when the partitioning element is situated, relative to the longitudinal axis of the contact area, at a distance of 2 mm to 10 mm from a contact point of the contact area or at a distance of 10 mm to 30 mm from the contact point of the contact area. The contact area is preferably that area into which a battery contact of a rechargeable tool battery engages, provided the rechargeable tool battery has been connected to the hand-held power tool as intended.

Further advantages result from the following description of the figures. The figures illustrate different exemplary embodiments of the present invention. The figures, the description and the claims contain numerous features in combination. Those skilled in the art will advantageously also consider the features individually and combine them to form other meaningful combinations.

### BRIEF DESCRIPTION OF THE DRAWINGS

In the figures, identical and equivalent components are provided with identical reference numerals.

FIG. 1 shows a schematic representation of a hand-held power tool according to the prior art;

FIG. 2 shows a schematic representation of an accommodating area of a hand-held power tool according to the present invention;

FIG. 3 shows a schematic perspective representation of an accommodating area of a hand-held power tool according to the present invention;

FIG. 4 shows a schematic representation of a contact area, a connection area, and a heat-conducting element for illustrating different possible positions of the partitioning element;

FIG. 5 show a schematic representation of a heat-conducing element including a heat sink;

FIG. 6 shows a unit which is formed from contact area, connection area, and heat-conducting element and is designed as a one-piece component.

### DETAILED DESCRIPTION

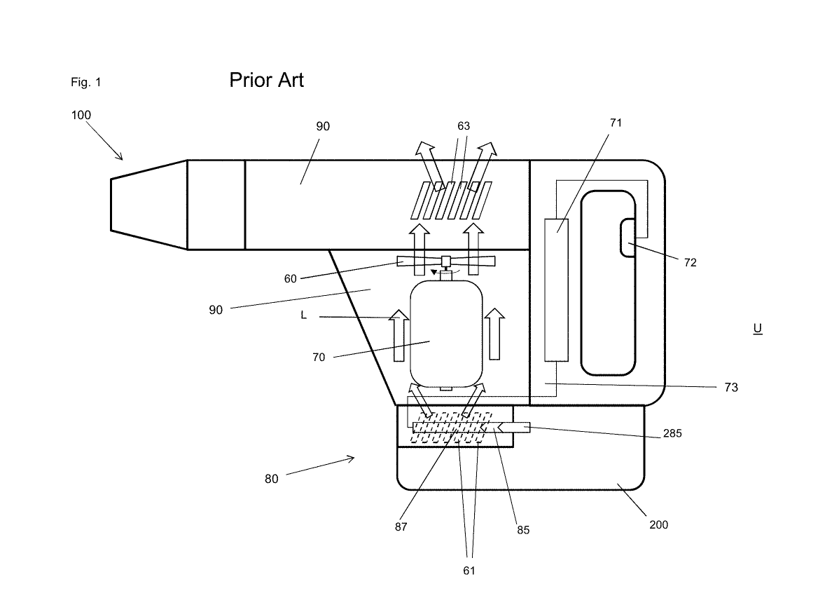

FIG. 1 shows a hand-held power tool 100 according to the prior art, specifically a hammer drill in the present case. Hand-held power tool 100 includes a tool housing 90 which includes an accommodating area 80 designed for accommodating a rechargeable tool battery 200. A contact area 85 for electrically contacting rechargeable tool battery 200 via its battery contact 285 is situated in accommodating area 80. Moreover, a connection area 87 for conducting a supply current provided by rechargeable tool battery 200 to an electric drive motor 70 is situated in accommodating area 80. Electric drive motor 70 is included in hand-held power tool 100.

In addition, hand-held power tool 100 includes a cooling fan 60 which is situated in tool housing 90 and is operated by electric drive motor 70. With the aid of cooling fan 60, cooling air L from surroundings U may be drawn in through accommodating area 80 for the purpose of cooling accommodating area 80. In this case, cooling air L, effectuated by cooling fan 60, is drawn in through air inlet 61 into accommodating area 80 in order to absorb, at this point, waste heat from connection area 87 and contact area 85. Cooling air L subsequently exits tool housing 90 at air outlet 63.

As may also be gathered from FIG. 1, contact area 85 is electrically connected to connection area 87 which, in turn, is connected via connection line 73 to a machine electronics system 71. Hand-held power tool 100 may be started up with the aid of a machine switch 72.

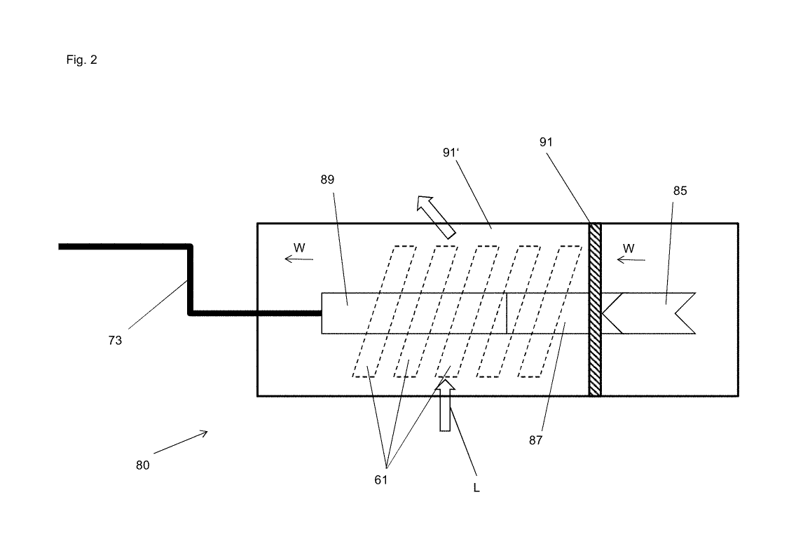

FIG. 2 shows an enlarged representation of an accommodating area 80 of a hand-held power tool 100 according to the present invention. In contrast to the hand-held power tool from the prior art described with reference to FIG. 1, accommodating area 80 in FIG. 2 includes a partitioning element 91 in the form of a partition wall which is provided in such a way that contact area 85 remains essentially free from cooling air drawn in through accommodating area 80.

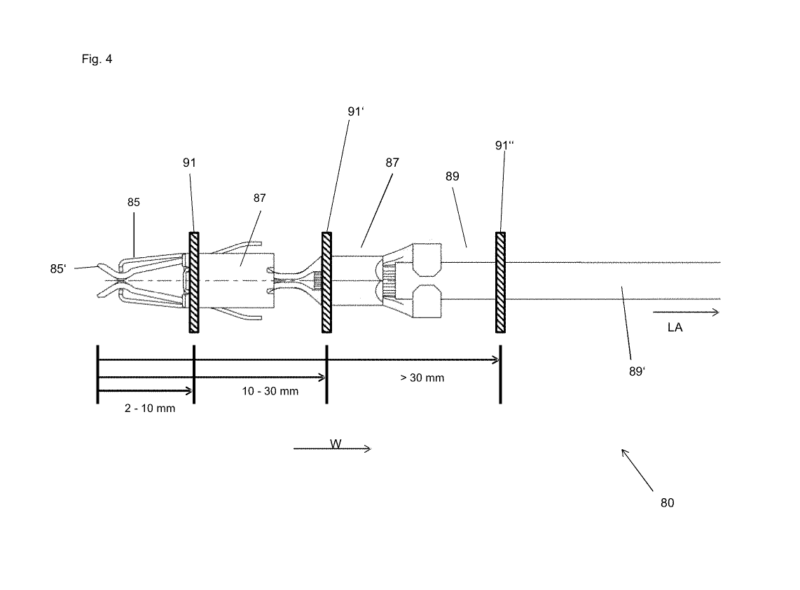

In the exemplary embodiment shown, partitioning element 91 is provided between contact area 85 and connection area 87, so that contact area 85 is partitioned off from connection area 87 in an essentially air-tight manner. Alternative possible positions of partitioning element 91 may be gathered from FIG. 4.

A heat-conducting element 89 is connected downstream from connection area 87 in the present exemplary embodiment from FIG. 2. Contact area 85, connection area 87, and heat-conducting element 89 are electrically and thermally conductively connected to each other. Therefore, on the one hand, a supply current provided by a rechargeable tool battery (not shown) may enter contact area 85 and, from there, may be conducted via connection area 87 and heat-conducting element 89 into connection line 73. Furthermore, a heat quantity W introduced into contact area 85 is dissipatable into connection area 87 and heat-conducting element 89 in order to be removed therefrom by cooling air flow L with the aid of convection.

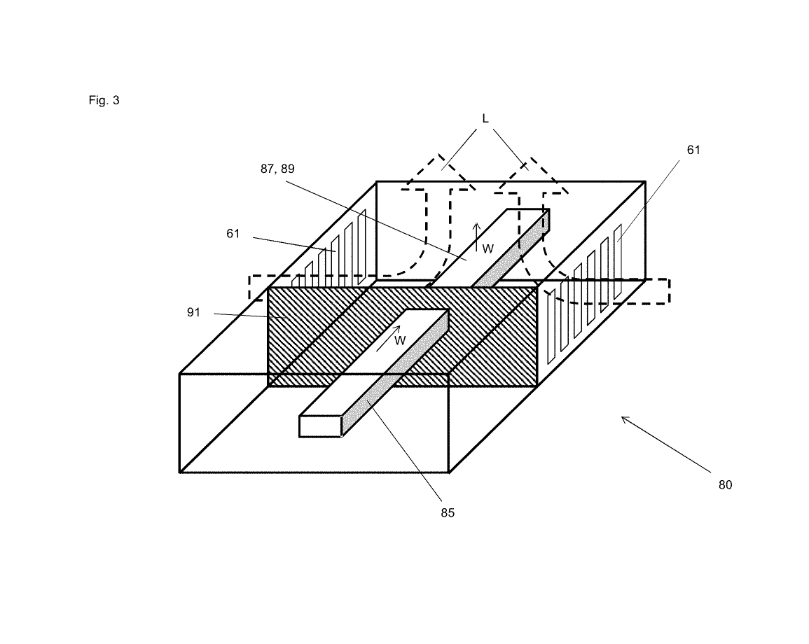

FIG. 3 shows a perspective representation of an accommodating area 80. As is readily apparent, partitioning element 91 is situated between contact area 85 and connection area 87 as a partition wall. The cooling air drawn in laterally through air inlets 61 is used for dissipating a heat quantity W which has been introduced into contact area 85 and, from there, has been conducted further into connection area 87 and heat-conducting element 89.

FIG. 4 illustrates possible positions at which a partitioning element 91 may be situated within an accommodating area 80. Particularly preferably, partitioning element 91 is situated between contact area 85 and connection area 87. In this case, partitioning element 91, relative to longitudinal axis LA of contact area 85, is situated at a distance of 2 mm to 10 mm from a contact point 85′ of the contact area. As may be gathered from FIG. 4 in the present case, the partitioning element in the form of a partition wall is situated precisely 10 mm away from contact point 85′ in the direction of longitudinal axis LA.

An alternative partitioning element 91′ is situated at a distance of 10 mm to 30 mm from contact point 85′ of contact area 85 relative to longitudinal axis LA of contact area 85. In the present case, alternative partitioning element 91′ is spaced precisely 30 mm from contact point 85′. If an alternative partitioning element 91′ is provided instead of partitioning element 91, both contact area 85 and connection area 87 are free from cooling air L drawn in through accommodating area 80. Therefore, heat is transported from contact area 85 into connection area 87 and, from there, into heat-conducting element 89 with the aid of thermal conduction. Heat quantity W is subsequently removed via convection with the aid of cooling air L which flows past heat-conducting element 89.

Yet another alternative partitioning element 91″ is situated at a distance of >30 mm from contact point 85′ of contact area 85 relative to longitudinal axis LA of contact area 85. If second alternative partitioning element 91″ is provided instead of partitioning element 91 and first alternative partitioning element 91′, a removal of a heat quantity with the aid of convection may take place only via remaining section 89′ of heat-conducting element 89.

As is also apparent from FIG. 4, contact area 85 is designed as a contact clamp in the present case, which is connected via a crimped joint included in connection area 87 to heat-conducting element 89, 89′ in the form of an insulated litz wire.

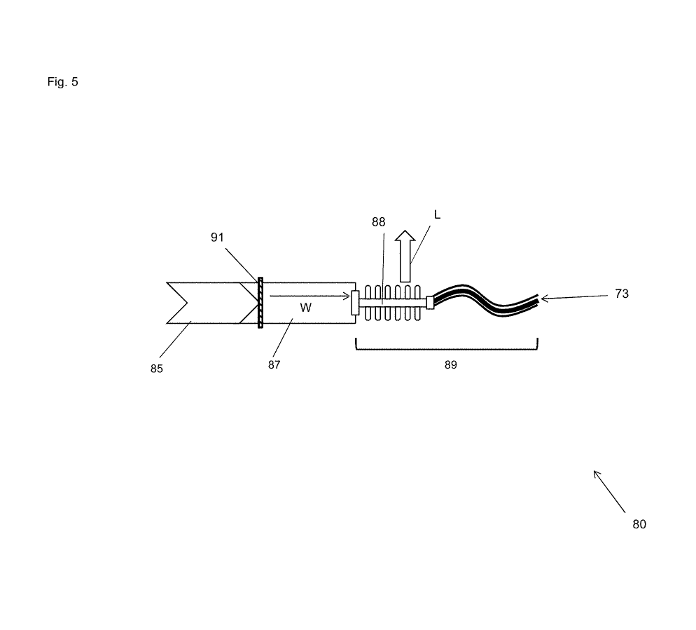

FIG. 5 shows an accommodating area 80 of a hand-held power tool 100 according to the present invention. Partitioning element 91 according to the present invention is provided as a partition wall between contact area 85 and connection area 87. Heat-conducting element 89 connected downstream from connection area 87 includes a heat sink 88 for the incident flow of cooling air L for the purpose of cooling. In the present exemplary embodiment, heat-conducting element 89 is formed, in sections, by an insulated litz wire which extends further, as connection line 73, in the direction of a machine electronics system, not shown. Via the litz wire, which is a part of heat-conducting element 89, a portion of the heat quantity introduced into contact area 85 may be dissipated.

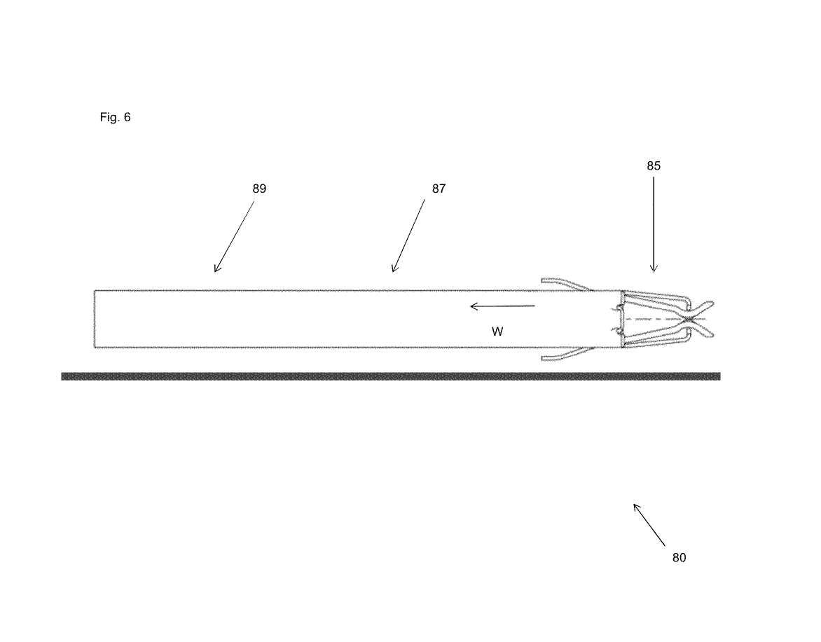

Finally, FIG. 6 shows an exemplary embodiment in which contact area 85, connection area 87, and heat-conducting element 89, together, are designed as a one-piece component, namely as a contact rail in the present case. By way of example, the contact rail is made of copper, so that contact area 85, connection area 87, and heat-conducting element 89 are electrically and thermally conductively connected to each other. The contact rail therefore acts as an electrical connection element and as a heat pipe.

### LIST OF REFERENCE NUMERALS

L cooling air
LA longitudinal axis of the contact area
W heat quantity
60 cooling fan
61 air inlet
63 air outlet
70 electric drive motor
71 machine electronics system
72 machine switch
73 connection line
80 accommodating area
85 contact area
87 connection area
88 heat sink
89 heat-conducting element
89′ remaining section of the heat-conducting element
90 tool housing
91 partitioning element
100 power tool
200 rechargeable tool battery
285 battery contact

What is claimed is:

1-10. (canceled)

11. A hand-held power tool comprising:
a tool housing having an accommodating area for accommodating a rechargeable tool battery;
a contact area for electrically contacting the rechargeable tool battery; and
a connection area electrically connected to the contact area and provided in the accommodating area, the connection area being configured for conducting a supply current provided by the rechargeable tool battery to an electric drive motor of the hand-held power tool;
a cooling fan situated in the tool housing and operated by the electric drive motor, cooling air drawable in, with the aid of the cooling fan, through the accommodating area for cooling the accommodating area; and
at least one partitioning element provided in the accommodating area so that the contact area remains free from cooling air drawn in through the accommodating area.

12. The hand-held power tool as recited in claim 11 wherein the partitioning element is a partition wall, a flexible seal, or a chamber.

13. The hand-held power tool as recited in claim 11 wherein the partitioning element is provided between the contact area and the connection area.

14. The hand-held power tool as recited in claim 11 wherein the contact area and the connection area are thermally conductively connected to each other, so that a heat quantity introduced into the contact area is dissipatable via the connection area.

15. The hand-held power tool as recited in claim 11 further comprising a heat-conducting element thermally conductively connected to the connection area and connected downstream from the connection area in a direction of a machine electronics system, so that a heat quantity introduced into the connection area is dissipatable via the heat-conducting element.

16. The hand-held power tool as recited in claim 15 wherein the heat-conducting element includes a heat sink for incident flow of cooling air for the purpose of cooling.

17. The hand-held power tool as recited in claim 15 wherein the heat-conducting element includes a current-carrying litz wire.

18. The hand-held power tool as recited in claim 15 wherein the contact area, the connection area, and the heat-conducting element, together, are designed as a one-piece component.

19. The hand-held power tool as recited in claim 18 wherein the one-piece component is a contact rail.

20. The hand-held power tool as recited in claim 15 wherein the connection area has a crimped joint or a welded joint for the electrical and thermally conductive connection of the heat-conducting element to the contact area or is formed by a crimped joint or a welded joint.

21. The hand-held power tool as recited in claim 11 wherein the partitioning element is situated, relative to the longitudinal axis of the contact area, at a distance of 2 mm to 10 mm from a contact point of the contact area.

22. The hand-held power tool as recited in claim 11 wherein the partitioning element is situated, relative to the longitudinal axis of the contact area, at a distance of 10 mm to 30 mm from the contact point of the contact area.

23. A hammer drill or combi-hammer comprising the hand-held power tool as recited in claim 11.
